(19) United States
(12) Patent Application Publication
(10) Pub. No.: US 2009/0141500 A1
(43) Pub. Date: Jun. 4, 2009

(54) LED FIXTURE

(76) Inventor: Chang-Hung PENG, Chung-Ho City (TW)

Correspondence Address: HDLS Patent & Trademark Services, P.O. BOX 220746, CHANTILLY, VA, 20153-0746, US

(21) Appl. No.: 12/100,148

(22) Filed: Apr. 9, 2008

(30) Foreign Application Priority Data
Dec. 4, 2007 (TW) 096220563

(51) Int. Cl. F21V 29/00

(52) U.S. Cl. 362/294

(57) ABSTRACT

An LED fixture of heat-dissipating type includes a lampshade, an LED lamp set and a power source connector. The lampshade is made of materials, such as aluminum, capable of thermal dissipation, and its interior is horizontally arranged a divider for being divided into a first space and a second space. The LED lamp set is thus arranged in the first space, while the power source connector is arranged in the second space. A fixing pole shown as a hollow configuration is arranged on the power source connector and projected into the second space with a fixing element arranged into its interior. In the present invention, the fixing element penetrates through the divider of the lampshade for being fixed to a light-reflecting shade of the LED lamp set, thus that an assembly can be achieved quickly with a significantly enhanced contact between the lampshade and the LED lamp set.

### BACKGROUND OF THE INVENTION

1. Field of the Invention

The present invention generally relates to a lighting device, in particular, to a fully assembled structure of light emitting diode (LED) fixture.

2. Description of Prior Art

Because of many merits such as high illumination, power saving, and long life, LED is comprehensively applied to illuminating fields of electronic devices or lamp fixtures. In order to enhance its illuminating range and brightness, a plurality of LED's are usually assembled into an LED lamp set. However, following the quantity increment and high power development of modern LED, LED's operationally generated heat is also rising gradually and consequently. Therefore, an LED with heat-dissipating structure has thus become an important issue studied by the persons engaged in such business.

If LED is going to be applied as a lighting source for a lamp fixture, it has to consider the heat-dissipating problem resulted from LED's high power inherence. A prior LED fixture, disclosed in a Taiwan Patent No. M320290 with a title of “Heat-Dissipating Structure of LED Lamp”, is mainly to arrange a plurality of cooling fins on LED's lampshade or lamp shell. Furthermore, the LED's circuit board and lampshade or lamp shell are attached together, such that the heat generated from the LED is absorbed and released by the cooling fins arranged on the lampshade or the lamp shell. However, according to the prior arts of such design, the circuit board and the lampshade or the lamp shell are usually connected by means of bolting or snapping, while other elements of the lamp fixture are designed with other assembling structures. Therefore, there is much trouble and inconvenience occurred in the assembling procedure. In the meantime, since a closer contact can not be achieved between the circuit board and the lampshade or the lamp shell, a poorly thermal conductivity is thus possessed by the prior LED fixture.

Accordingly, aiming to solving the aforementioned shortcomings, after a substantially devoted study, in cooperation with the application of relatively academic principles, the inventor has at last proposed the present invention “LED Fixture” that is designed reasonably to possess the capability to improve the prior arts significantly.

### SUMMARY OF THE INVENTION

The invention is mainly to provide an LED fixture fixed by a penetrating-through means. Not only can each element be assembled simultaneously, but also can a closer contact be further achieved between the LED lamp set and the lampshade providing cooling effectiveness, such that the objectives of easy assembly and cooling enhancement can be achieved.

Secondly, the invention is to provide an LED fixture including a lampshade, an LED lamp set, and a power source connector. The lampshade is made of materials, such as aluminum, capable of thermal dissipation, and its interior is horizontally arranged a divider for being divided into a first space and a second space. The LED lamp set is thus arranged in the first space, while the power source connector is arranged in the second space. A fixing pole shown as a hollow configuration is arranged on the power source connector and projected into the second space with a fixing element arranged into its interior. According to the present invention, the fixing element penetrates through the divider of the lampshade for being fixed on a light-reflecting shade of the LED lamp set, thus that an assembly can be achieved quickly with a significantly enhanced contact between the lampshade and the LED lamp set.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a perspective explosive view according to the present invention;

FIG. 2 is a perspective assembled view according to the present invention; and

FIG. 3 is a cross-sectional view based on a “3-3” section after the elements of FIG. 1 have been assembled.

### DETAILED DESCRIPTION OF THE INVENTION

In cooperation with attached drawings, the technical contents and detailed description of the invention are described thereinafter according to a preferable embodiment, being not used to limit its executing scope. Any equivalent variation and modification made according to appended claims is all covered by the claims claimed by the present invention.

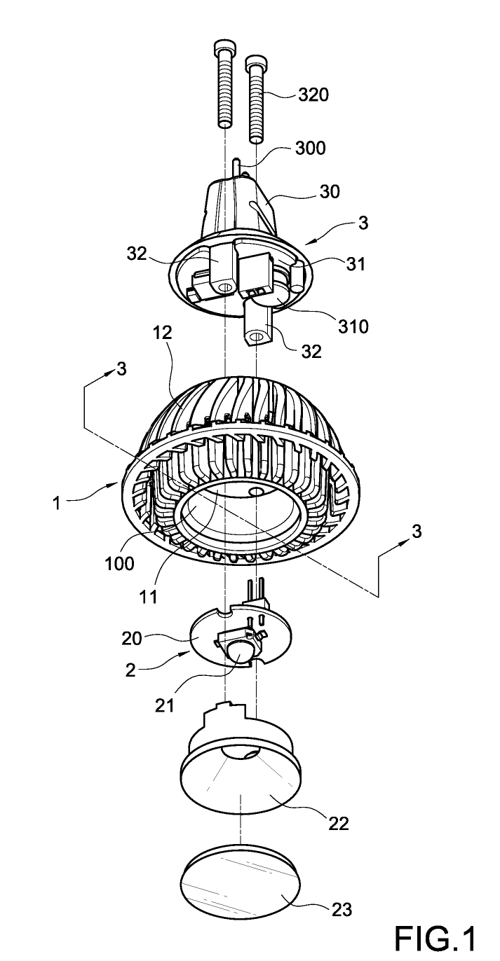

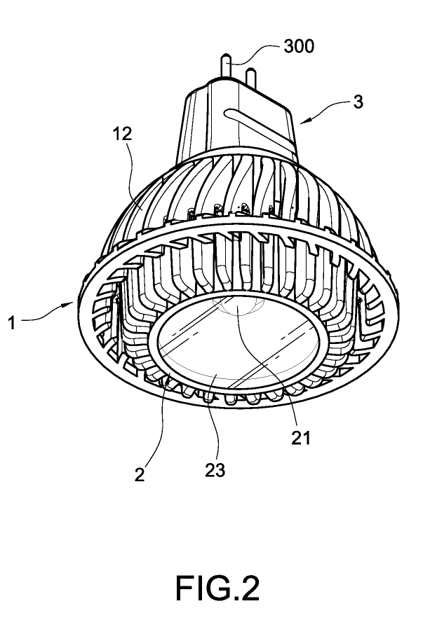

Please refer to FIG. 1 through FIG. 3. The invention is to provide an LED fixture, which includes a lampshade 1, an LED lamp set 2, and a power source connector 3.

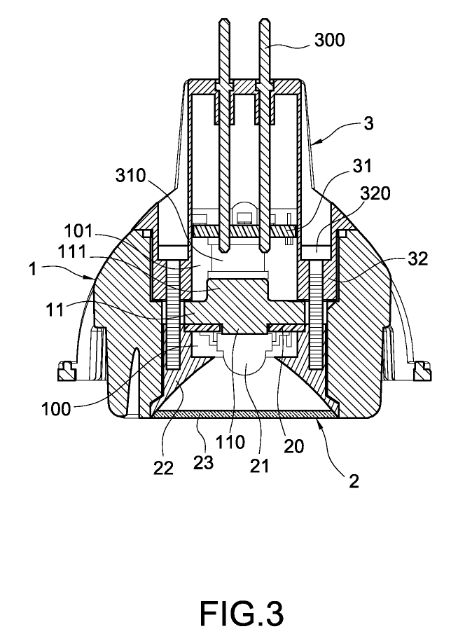

As shown in FIG. 3, the lampshade 1 is integrally made of materials capable of excellently thermal conductivity such as aluminum. According to a preferable embodiment, a divider 11 is arranged across the middle section of a main body 10 that is shown as a cup configuration and divided into a first space 100 and a second space 101. In addition, a plurality of cooling fins 12 are arranged at lateral surroundings of the main body 10 and extended outwardly to provide the necessary cooling.

In this case, the LED lamp set 2 arranged in the first space 100 of the main body 10 of the lampshade 1 includes a circuit board 20, at least one LED 21 arranged on the circuit board 20, a light-reflecting shade 22 covering around the outer circumference of the LED 21 and a lens 23 arranged over an opening of the light-reflecting shade 22 and cast by the light of the LED 21. A back of the circuit board 20 is attached onto the divider 11 of the main body 10 of the lampshade 1. A first heat-conducting block 110 is attached onto a bottom part of the LED 21 by being projected toward the first space 100, making the heat generated from the LED 21 absorbed by the main body 10 of the lampshade 1 by means of a thermal contact. Furthermore, the generated heat can be transferred to each cooling fins 12 arranged on the main body 10 of the lampshade 1 through the divider 11, and thus the cooling requirement of the LED 21 can be fulfilled by such heat release.

The power source connector 3 is arranged in the second space 101 of the main body 10 of the lampshade 1 and has an inserting part 30 extended outwardly. There is at least one inserting leg 300 arranged at the front side of the inserting part 30, while the back side of the inserting part 30 is inset a control circuit board 31 and at least one fixing pole 32 extended into the second space 101. In this case, a single or various electronic elements 310 are arranged on the control circuit board 31, having the functions such as the change from AC to DC. The fixing pole 32 shown as a hollow configuration is provided for fixing element 320 to pass through such as a bolt.

As shown in FIG. 3, the invention is mainly to provide a fixing pole 32 that penetrates through the power source connector 3 to provide the fixing element 320 to be placed into the back side of the inserting part 30 near the inserting leg 300. After the fixing element 320 passes through the divider 11 of the main body 10 of the lampshade 1, the end side of the fixing element 320 is screwed into the light-reflecting shade 22 of the LED lamp set 2. Thereby, the power source connector 3, the lampshade 1, and the light-reflecting shade 22 of the LED lamp set 2 are screwed integrally. Since the three elements are penetrated through and screwed together by the fixing element 320, the circuit board 20 of the LED lamp set 2 can be abutted onto the divider 11 of the main body 10 of the lampshade 1. In the meantime, a first heat-conducting block 110 located on the divider 11 can be tightly contacted to the bottom of the LED 21. Accordingly, there is an effectively enhancing contact existed between the LED lamp set 2 and the main body 10 of the lampshade 1 to possess of an excellently thermal conductivity. Furthermore, it is easier, simpler and quicker in terms of assembling procedure.

In addition, the invention can further arrange a second heat-conducting block 111 to the divider 11 of the lampshade 1 and to be extended into the second space 101. The second heat-conducting block 111 contacts the electronic element 310 for easily conducting a thermal transfer. The second heat-conducting block 111 not only can make each cooling fins 12 help the LED 21 processing heat dissipation, but also can control the heat dissipation needed by the electronic element 310 of the control circuit board 31.

Accordingly, by the composition of above structure, an LED fixture according to the invention is thus obtained.

In sum, an LED fixture of the invention is to make the fixing element 320 sequentially pass through the power source connector 3 and the lampshade 1 and finally screwed into the light-reflecting shade 22 of the LED lamp set 2. Thereby, the cup lamp can be integrally assembled by each element. In the meantime, the heat transferring effectiveness is further enhanced, due to a close contact between the LED lamp set 2 and the lampshade 1.

According to aforementioned description, the invention is a novel structure for an LED fixture indeed, which may positively reach the expected usage objective for solving the drawbacks of the prior arts, and which extremely possesses the innovation and progressiveness to completely fulfill the applying merits of new type patent, according to which the invention is thereby applied. Please examine the application carefully and grant it as a formal patent for protecting the rights of the inventor.

Moreover, the aforementioned description is only a preferable embodiment according to the present invention, being not used to limit the patent scope of the invention, so equivalently structural variation made to the contents of the present invention, for example, description and drawings, is all covered by the claims claimed thereinafter.

What is claimed is:

1. An LED fixture of heat-dissipating type, including
a lampshade, of which an interior shown as a hollow configuration is horizontally arranged a divider, by which the lampshade is divided into a first space and a second space;
an LED lamp set, which is arranged in the first space and includes a circuit board attached onto the divider, an LED arranged on the circuit board, and a light-reflecting shade arranged around an outer circumference of the LED; and
a power source connector, which is arranged in the second space of the lampshade, and on which a fixing pole shown as a hollow configuration is arranged to be extended into the second space and has a fixing element penetrating through an interior of the fixing pole;
wherein the fixing element passes through the divider of the lampshade and is fixed to the light-reflecting shade of the LED lamp set.

2. The LED fixture of heat-dissipating type according to claim 1, wherein the lampshade is made of materials capable of excellently thermal dissipation.

3. The LED fixture of heat-dissipating type according to claim 1, wherein a plurality of cooling fins are arranged around lateral surroundings of the lampshade and extended outwardly.

4. The LED fixture of heat-dissipating type according to claim 1, wherein a first heat-conducting block is attached onto a bottom part of the LED from the divider of the lampshade toward the first space.

5. The LED fixture of heat-dissipating type according to claim 1, wherein a lens is arranged over an opening of the light-reflecting shade and is provided for being cast by a light emitted from the LED.

6. The LED fixture of heat-dissipating type according to claim 1, wherein the power source connector has a control circuit board that is located in the second space and has an electronic element arranged thereon, and wherein a second heat-conducting block that is arranged from the divider of the lampshade toward the second space can make a thermal conduction with the electronic element.

7. The LED fixture of heat-dissipating type according to claim 1, wherein the fixing element is a bolt.
